(19) United States
(12) Patent Application Publication
(10) Pub. No.: US 2009/0249427 A1
(43) Pub. Date: Oct. 1, 2009

(54) SYSTEM, METHOD AND COMPUTER PROGRAM PRODUCT FOR INTERACTING WITH UNALTERED MEDIA

(75) Inventors: Anthony DUNNIGAN, Berkeley, CA (US); John Doherty, San Francisco, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/055,268

(22) Filed: Mar. 25, 2008

(51) Int. Cl. H04N 7/173

(52) U.S. Cl. 725/133; 725/115

(57) ABSTRACT

An interactive media player that allows users to view, discuss and interact with any video or audio segment that is owned by the users. In one aspect, a video player graphical user interface presents a video segment in its native, unaltered format and surrounds the video segment with interactive elements with which a user can view related content or create commentary and new content. By tracking metadata such as chapter, timecode, caption and other descriptive information from the video segment, advanced interactions with other users on a network playing the same video segment will be supported without the need to re-encode or duplicate the original video segment. Users can also create new content, such as commentary, audio or video clips that can be associated with a specific section of the video segment and stored on the network so that other users can view and interact with the newly-created content.

### BACKGROUND OF THE INVENTION

1. Field of the Invention

The present invention generally relates to interaction between users and interaction between users and digital media. More specifically, the present invention relates to a system, method and computer program product for enabling interaction between users in a network and for enabling viewing of and interaction with unaltered digital media.

2. Background of the Invention

Many users bring segments of their favorite television shows, music videos or movies with them into online social spaces. Once these segments nave been brought into an online social space they are commented upon or “mashed-up” with other content. These popular activities generally infringe upon the rights of the content owners.

Many collaborative viewing environments require copying, processing and storing of the original video file in some way, even if only in a cache. As of 2006, YouTube (www.youtube.com) contained 45 terabytes of videos and is growing quickly. 12.8 million people per week visit the site. Both males and females visit YouTube (60/40 split). On Jun. 18, 2007 more than 3 million people had commented on the top 10 most popular videos. Of those viewers, 0.5 percent added new content to the video (in the form of unique comments). A smaller number of viewers generate new video content to “answer” a previous video.

Of the 6,725 most viewed YouTube videos, 621, or 9.23 percent, were removed because of reported copyright violations. Given the massive number of videos YouTube serves on a daily basis this still represents a huge number of clips excerpted from copyrighted material. This survey did not look at the vast majority of clips but only the most popular ones. These copyrighted clips as well as still images are often referenced by movie discussion websites like http://www.trekweb.com or http://spoilerslost.blogspot.com. Users of these sites spend a great deal of time discussing programs in detail and these clips serve to illustrate their arguments.

Nearly 90 percent of the college students interviewed in a recent study upload Internet videos containing copyrighted material to user-generated video sites without permission from copyright owners—but 74 percent of them do believe it would be fair to pay for the use of such material. 76 percent of respondents said the Fair Use doctrine—which permits use of unauthorized copyrighted material under some circumstances—allows them to use copyrighted material, but not a single student could accurately define the doctrine. More than half of respondents (52 percent) combine their own videography with recorded music; 44 percent put together moving slide shows with photos of family and friends; and 20 percent excerpted material from a TV show or movie.

Content owners release multiple versions of their programs in order to attract buyers. “Special Edition” DVDs almost always follow standard releases (an unpopular practice known as double dipping). Over time the number of “Special Edition” versions of popular movies increases, sometimes to 3 or 4 different versions of the same film. With DVD sales on the decline, there is fear that buyer fatigue is setting in.

DVDs commonly contain advertisements for related titles. These are presented before the main video program. This method is both obtrusive and hard to derive sales metrics from.

Thus, it is desired to develop systems and methods for users to interact with each other while viewing video or audio segments that do not violate copyright laws. It is also desired to develop systems and methods for associating and displaying content related to a video or audio segment for viewing and interacting by a user.

### SUMMARY OF THE INVENTION

The present invention relates to a system, method and computer program product for users to interact with each other in a network while viewing and interacting with an unaltered media clip that is legally owned by each user. In one embodiment, an interactive video player plays an unaltered video segment while displaying at least one interactive element with which a user can view content related to the video segment or create new content to share with other users. Further, users can also create new content, such as commentary, audio or video clips that can be associated with a specific section of the video segment and stored on the network so that other users can view and interact with the newly-created content.

In accordance with one aspect of the inventive concept, there is provided a system for viewing and interacting with unaltered content. The inventive system incorporates a storage module operable to store unaltered content; a processing module configured to receive a content related to the unaltered content from a network and to associate the received related content with at least one portion of the unaltered content and a display module configured to generate a graphical user interface, the graphical user interface adapted to display the unaltered content and at least one interactive element containing the related content to a user. The inventive system further includes at least one input device operable to enable the user to create new content related to the unaltered content.

In accordance with another aspect of the inventive concept, there is provided a method involving selecting at least a portion of unaltered content; receiving a content related to the selected portion of the unaltered content from a network; and viewing the segment of unaltered content on a display along with at least one interactive element including the related content.

In accordance with yet another aspect of the inventive concept, there is provided a computer program product embodied on a computer readable medium for displaying a video segment and a plurality of interactive elements, the computer program product including computer-readable instructions for displaying the video segment using a graphical user interface, wherein the video segment is unaltered. The inventive method further involves receiving multiple, content related to the video segment from a network and displaying the multiple of related content using at least one interactive element of the graphical user interface.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 depicts an illustration of a system for user interaction while viewing an unaltered media clip, according to one aspect of the invention;

FIG. 2 depicts an illustration of a graphical user interface of a video player for displaying a video segment along with an interactive element, according to one aspect of the invention;

FIG. 3 depicts an illustration of the graphical user interface of the video player with an additional interactive element, according to one aspect of the invention;

FIG. 4 depicts a block diagram of a method for interacting with multiple users for viewing and interacting with media, according to one aspect of the invention;

FIG. 5 depicts an illustration of a graphical user interface for a user to interact with other users while viewing a video by posting comments, according to one aspect of the invention; and

FIG. 6 illustrates an exemplary embodiment of a computer platform upon which the inventive system may be implemented.

### DETAILED DESCRIPTION OF THE INVENTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The present invention relates to systems and methods operable to enable users to interact with each other in a network while viewing and interacting with an unaltered media clip, a copy of which is legally owned by each user, or which the user has a legal right to watch. In one exemplary embodiment, an interactive video player plays a video content, a copy of which is legally owned by a user or which the user otherwise has a legal right to watch, while also displaying interactive elements for the user to view, comment upon and otherwise interact with. In accordance with an embodiment of the invention, the interactive elements viewed by the user are not incorporated into the content, which, therefore, remains unaltered.

The interactive elements contain other content related to the video content and permit a user to interact with other users viewing the same video content using an embodiment of the inventive video player. Further, the user can create new content related to the video content that is then associated with the video content and displayed on the user interface of the inventive video player to other users so that other users can view and interact with the newly-created content.

Because copies of the media clips played by the video player are owned or licensed by the user, the system supports the activities that the users are engaging in without violating any copyright laws and without requiring any additional licensing fees. Therefore, users can interact with other users who all own legal copies of the media clips and who are all viewing their own copies of the media clips from then own media libraries or computers.

An embodiment of the inventive system enables online communities to interact with digital versatile disc (“DVD”), video compact discs (“VCD”), high-definition DVD (“HD-DVD”), Blu-Ray DVD or any other commercially available digital video in a way that respects the rights of the respective content owners. While other collaborative video sharing environments require copying, processing and storing the original video file in some way (if only in a cache), the system described herein accesses only the information that the video playback format presents natively in order to establish the base ground for users' comments, hyperlinks, bookmarks or other collaborations. For example, DVDs are authored to a player standard that instructs the DVD player to play the underlying MPEG file. At a minimum, these player instructions present the playback technology with sufficient information to start and stop the video playback or return to identifiable points in the video file.

All commercially available videos have a set of unique identifiers. For example, DVDs are well described in several different header files that precede data packets. Not all header information is complete for every DVD, but for all DVDs, enough information will be present to identify the disc. It is even possible to use the Copy Protection Information File to identify the disc in some cases. Since these files are quite small and are always placed in known locations, identifying a disc in this manner takes very little time. A similar method is used by Compact-Disc Databases (“CDDB”) to identify audio CDs. Similarly downloaded video files, when legally purchased, contain descriptive headers.

All DVD, VCD, HD-DVD and Blu-Ray discs contain small, standardized presentation applications. These files can be mined for more information, including chapter information and captions.

In accordance with an embodiment of the invention, by combining all of this information, a useful description of a video program is generated. This description generally includes the name of the program, the version of the program, the timecode of the program, one or more caption tracks and all chapter information for the program. The differences between versions of the same program can be adjusted for due to the granularity of the description of the video content. Unlike other video commenting systems, the system described herein recognizes video programs and can merge new content from many sources. For example, a list of commentary tracks that were created by various users at various times can be automatically presented to a viewer.

With the embodiment described herein, it is possible to associate new content from multiple sources with the description of the original content as opposed to the actual content. This new content might take the form of audio or text commentaries. It might also take the form of blogs or “video wikis.” This new content can only be experienced with the underlying video by owners of the original content, regardless of the version. No original material is ever copied. In order to view a segment of video, the original program must be available to the user.

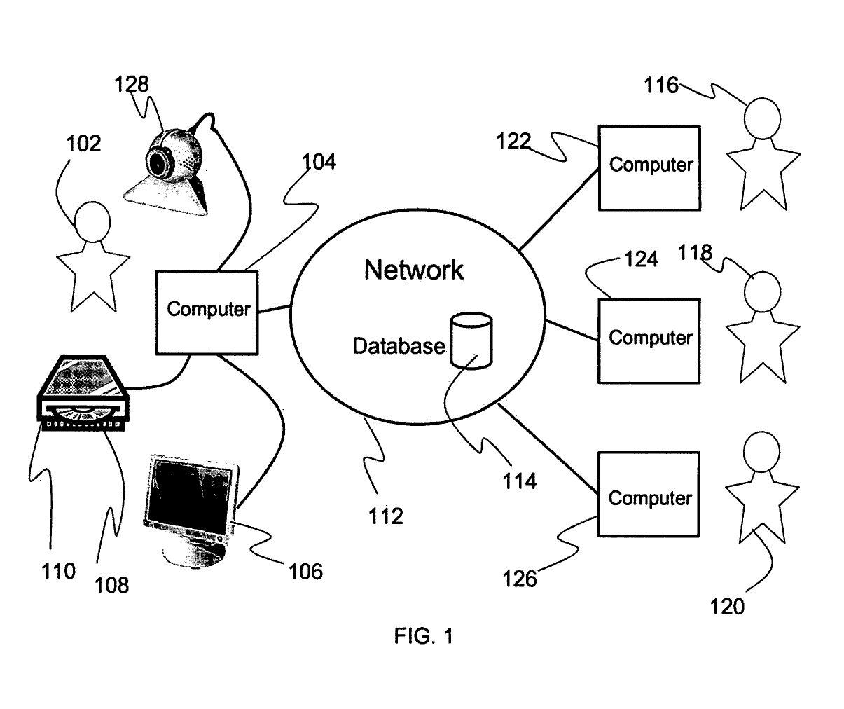

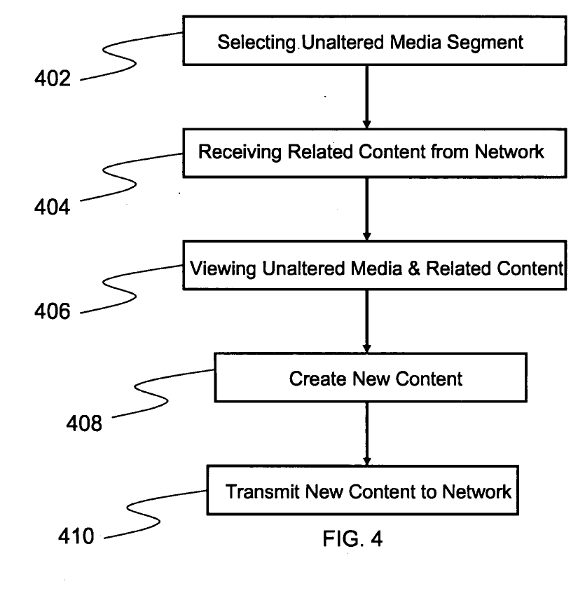

FIG. 1 illustrates one embodiment of a system for user interaction while viewing an unaltered media clip, and FIG. 4 similarly illustrates one embodiment of a method for interacting with multiple users to view and interact with the unaltered media clip. A user 102 with a computer 104 first selects a segment of unaltered media to view on a display 106 (step 402). The unaltered media is, for example, a DVD disc 108 that is loaded to the computer 104 using a disc drive 110. Once the selected segment of unaltered media is loaded onto the computer, a computer program product running on the computer 104 will identify the DVD disc 108 using the metadata described above, and then communicate with a network 112 to receive a variety of content related to the unaltered media (step 404). In one embodiment, the network 112 comprises a database 114 which stores the content related to the unaltered media. The content related to the unaltered media is created, in this embodiment, by a plurality of other users 116, 118, 120 with their own respective computers 122, 124, 126 running a similar computer program product. The related content is then presented to the user 102 along with the unaltered media so the user 102 can view the related content and the unaltered media (step 406) and interact with the other users 116, 118, 120. In the embodiment described herein, the user 102 may use an input device such as a webcam 128 to create new content such as a video commentary or a replacement scene that is related to the unaltered media (step 408). The new content can then be saved on the user's computer 104 and transmitted to the network 112 to be stored on the database 114 and distributed out to the other users 116, 118, 120 (step 410).

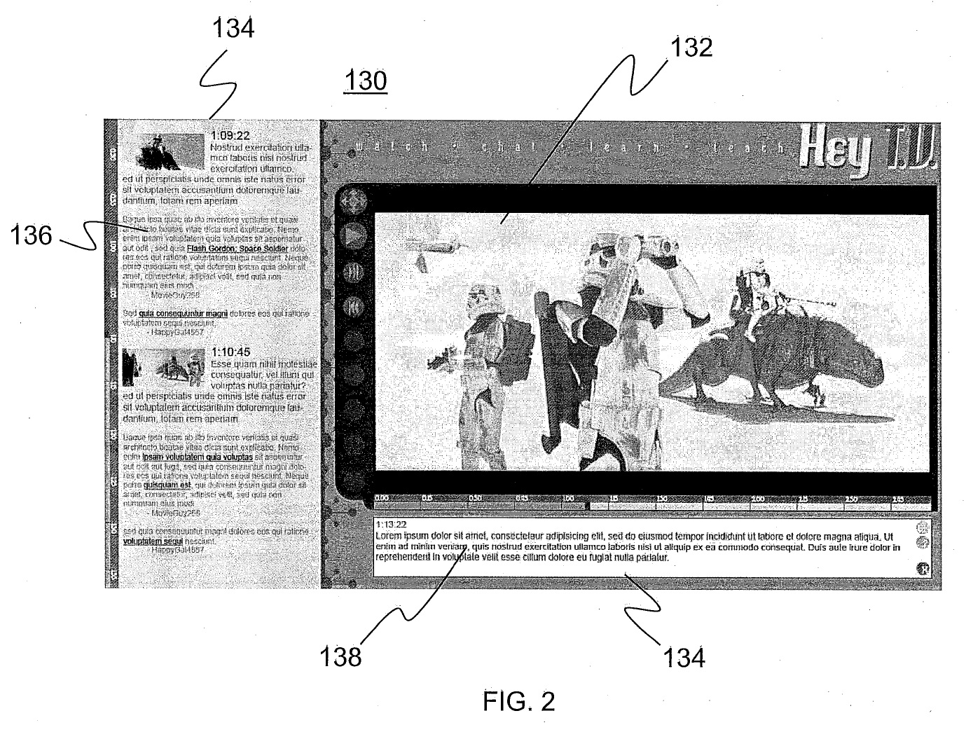

In one embodiment, the computer 104 displays the unaltered media and related content as a graphical user interface (“GUI”) 130, as shown in FIG. 2. The GUI 130 is, in this embodiment, a video player 132 surrounded by a plurality of interactive elements 134 for displaying the content related to the unaltered media. In the illustration of the GUI in FIG. 2, the interactive elements 134 include written commentary 136 associated with certain segments of the unaltered media. In FIG. 2, a second interactive element 134 includes a written summary of each scene 138 placed below the video player 132.

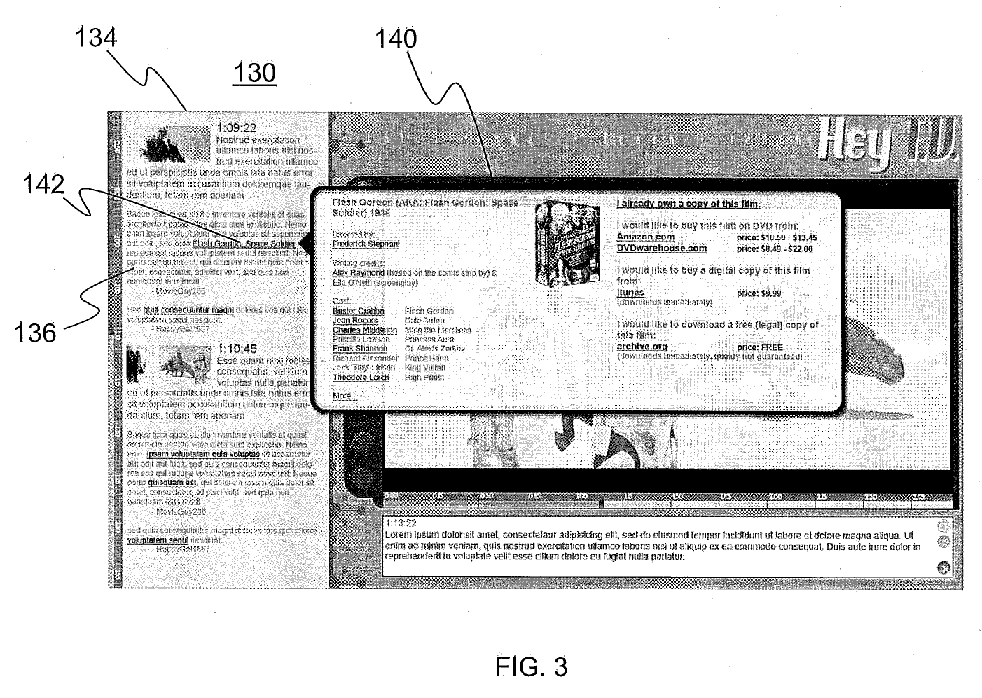

FIG. 3 illustrates another embodiment of a GUI 130, with an additional interactive element 134 represented by the pop-up window 140. The pop-up window 140 is associated with a hyperlink 142 in the commentary 136, and displays additional content related to the unaltered media. In this particular embodiment, the pop-up window 140 provides the user 102 with an opportunity to learn about a film related to the unaltered media, including the option to purchase the film by various means and through various vendors.

In one embodiment, as described briefly above, users may wish to make self-authored replacement video scenes available; also known as user-generated video (“UGV”). In this case, the network database 114 remotely stores the sharable UGV material, and the video player 132 would switch between the original content and the new content automatically. Users 102 holding the underlying rights to the unaltered video could offer access to video snippets as a pay service, allowing for follow on sales.

As envisioned in the embodiment described above, the user interaction begins as the video player 132 starts a video program. The presence of a valid video program is the key to all of the additional content provided by the system. In another embodiment, users 102 who hold the rights to the unaltered media may wish to make streaming versions of their video programs available to users who have presented the system with a valid copy of that program. This removes the need for users to re-insert their video discs for each viewing, or when they are linking more than one program together.

In another embodiment, the system allows users who own the unaltered content to sell additional material to other users without requiring the users to re-purchase the main video program (“double dipping”), as is required when purchasing a special edition DVD, for example. As shown in the pop-up window 140 in FIG. 3, the system may also allow for the sale of additional titles by making recommendations based upon the users' interactions. Since all purchases facilitated by this system are made within the context of an interaction with a given video program, sales information is easier to track.

The system also allows for many free services that also add value to the original program. Users could subscribe to “fan networks” that allow for real time interactions as well as more traditional discussion groups or fan generated commentaries. Finally, many of the user interactions will lead to other content (e.g. movies with similar themes). The system could allow for the instant purchase of this content, as described in the pop-up window 140 of FIG. 3.

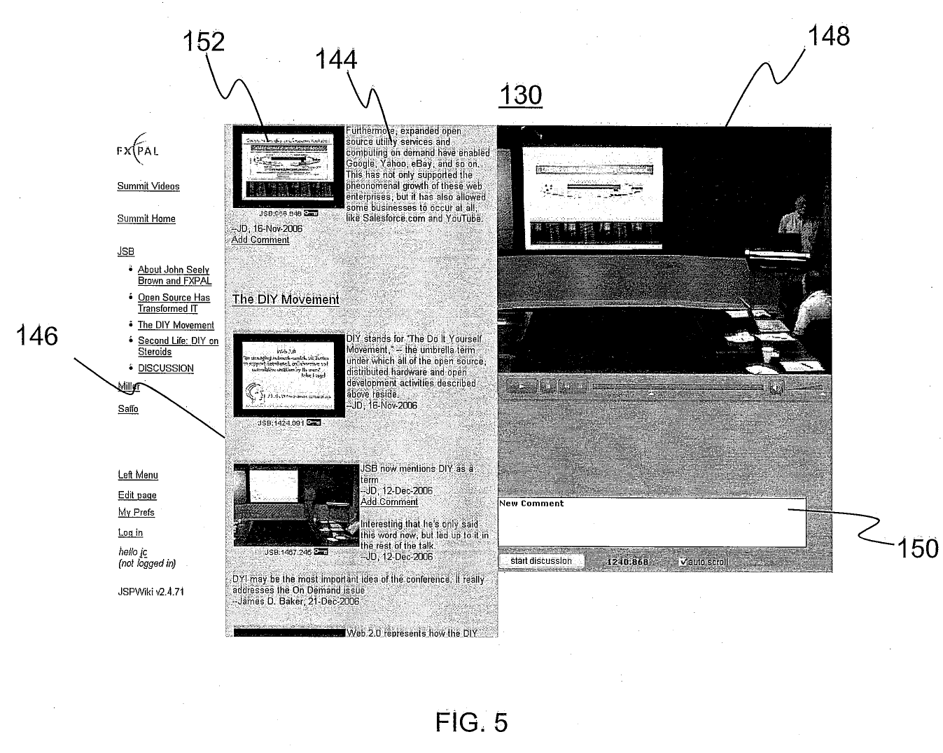

FIG. 5 an illustration of an exemplary graphical user interface 130 for a user to interact with other users by posting comments 144 to a commentary section 146 while viewing a video 148 on the video player 132. At any selected scene of the video 148, the user can enter a comment in the comment box 150, and the entered comments 144 will then appear in the commentary section 146 alongside a thumbnail image 152 of the scene of the video where the comment 144 was entered. Other users viewing the same GUI 130 may then see the comments 144 posted by other users and post their own comments to start a discussion of the video 148.

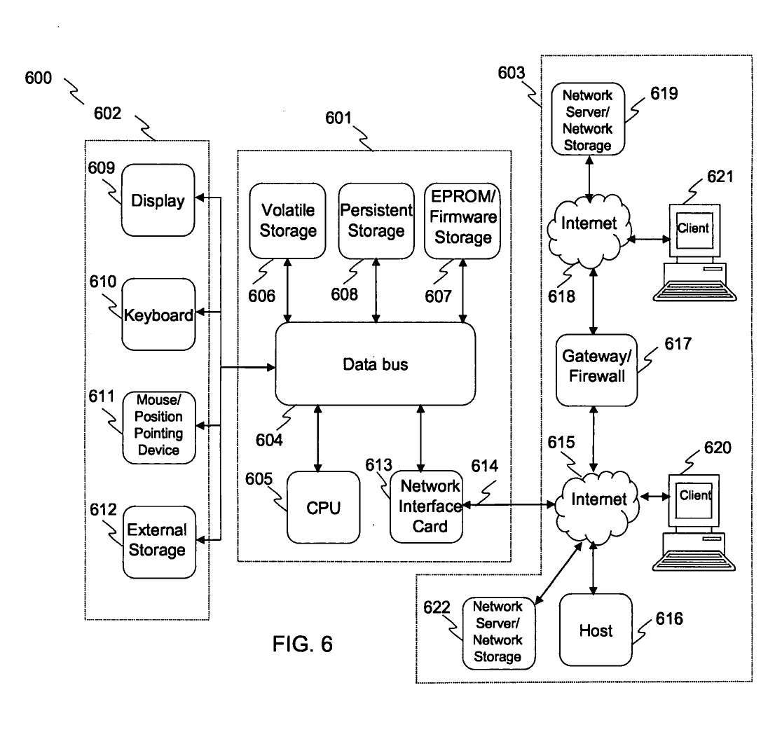

FIG. 6 is a block diagram that illustrates an exemplary embodiment of a computer/server system 600 upon which an embodiment of the inventive methodology may be implemented. The system 600 includes a computer/server platform 601, peripheral devices 602 and network resources 603.

The computer platform 601 may include a data bus 604 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 604 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 604 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 604 to a display 609, such as a cathode ray tube (CRT), plasma display, or a liquid crystal display (LCD), for displaying information to a system administrator or user of the computer platform 601. An input device 620, including alphanumeric and other keys, is coupled to bus 601 for communicating information and command selections to processor 605. Another type of user input device is cursor control device 611, such as a mouse, a trackball, or cursor direction keys for communicating direction information and command selections to processor 604 and for controlling cursor movement on display 609. This input device typically has two degrees of freedom in two axes, a first axis (e.g., x) and a second axis (e.g., y), that allows the device to specify positions in a plane.

An external storage device 612 may be connected to the computer platform 601 via bus 604 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 608. Volatile media includes dynamic memory, such as volatile storage 606. Transmission media includes coaxial cables, copper wire and fiber optics, including the wires that comprise data bus 604. Transmission media, can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on the data bus 604. The bus 604 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 604. Communication interface 613 provides a two-way data communication coupling to a network link 614 that is connected to a local network 615. For example, communication interface 613 maybe an integrated services digital network (ISDN) card or a modem to provide a data communication connection to a corresponding type of telephone line. As another example, communication interface 613 maybe a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 614 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients 620 and 621 may themselves be implemented based on the computer platform similar to the platform 601.

Local network 615 and the Internet 618 both use electrical, electromagnetic or optical signals that carry digital data streams. The signals through the various networks and the signals on network link 614 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 614 and communication interface 613. In the Internet example, when the system 601 acts as a network server, it might transmit a requested code or data for an application pro gram running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution. In this manner, computer system 601 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the system for viewing and interacting with unaltered media. It is intended that all matter contained in the above description or shown in the accompanying drawings shall be interpreted as illustrative only and not limiting.

What is claimed is:

1. A system for viewing and interacting with unaltered content, the system comprising:
a) a storage module operable to store unaltered content;
b) a processing module operable to receive a content related to the unaltered content from a network and to associate the received related content with at least one portion of the unaltered content;
c) a display module operable to generate a graphical user interface, the graphical user interface operable to display the unaltered content and at least one interactive element containing the related content to a user; and
d) at least one input device operable to enable the user to create new content related to the unaltered content.

2. The system of claim 1, wherein the processing module is operable to associate the received related content with the at least one portion of the unaltered content using metadata corresponding to the unaltered content and the content related to the unaltered content.

3. The system of claim 1, wherein the new content comprises comments on the unaltered content.

4. The system of claim 1, wherein the new content comprises a modified excerpt of the unaltered content.

5. The system of claim 1, wherein the new content is associated with appropriate segments of the unaltered content using metadata from the unaltered media and the content related to the unaltered content.

6. The system of claim 5, wherein the new content is transmitted to the network for display to other users with similar unaltered content.

7. The system of claim 6, wherein the network comprises a storage device for storing the related content transmitted to the computer and for storing the new content transmitted to the network.

8. The system of claim 1, wherein the unaltered content comprises video.

9. The system of claim 1, wherein the unaltered content comprises audio.

10. The system of claim 1, further comprising a network interface operable to receive the unaltered content from the network.

11. A method comprising:
selecting at least a portion of unaltered content;
receiving a content related to the selected portion of the unaltered content from a network; and
viewing the segment of unaltered content on a display along with at least one interactive element comprising the related content.

12. The method of claim 11, further comprising associating the related content with the unaltered content using metadata corresponding to the unaltered content and the related content.

13. The method of claim 11, further comprising creating new content associated with the segment of unaltered content.

14. The method of claim 13, further comprising associating the new content with at least second portion of the unaltered content using metadata corresponding to the unaltered content and the related content.

15. The method of claim 14, further comprising transmitting the new content using the network for display to other users, who are viewing a similar unaltered content.

16. The method of claim 15, further comprising storing the new content and the related content on a storage device in the network.

17. The method of claim 11, wherein the unaltered content comprises a video and wherein the selected portion of the unaltered content comprises a video segment.

18. The method of claim 11, wherein the unaltered content comprises an audio and wherein the selected portion of the unaltered content comprises an audio segment.

19. The method of claim 11, further comprising obtaining the unaltered content from the network.

20. A computer program product embodied on a computer readable medium for displaying a video segment and a plurality of interactive elements, the computer program product including computer-readable instructions for:
displaying the video segment using a graphical user interface, wherein the video segment is unaltered;
receiving a plurality of content related to the video segment from a network; and
displaying the plurality of related content using at least one interactive element of the graphical user interface.

21. The computer program product of claim 20, wherein the video segment is stored on the computer-readable medium.

22. The computer program product of claim 21, wherein the content comprises metadata from the video segment.

23. The computer program product of claim 22, further comprising computer-readable instructions causing the user interface to enable a user to input new content related to the video segment.

24. The computer program product of claim 23, further comprising computer-readable instructions for uploading the new content to a network for display to other users.
